(19) United States
(12) Patent Application Publication
(10) Pub. No.: US 2010/0089473 A1
(43) Pub. Date: Apr. 15, 2010

(54) Method for checking the operability of an actuator

(76) Inventors: Nicolas Grein, Kandel (DE); Matthias Schneider, Kraichtal (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/597,931

(22) PCT Filed: Apr. 25, 2008
(86) PCT No.: PCT/EP08/55104

§ 371 Date: Oct. 28, 2009

(30) Foreign Application Priority Data
May 2, 2007 (DE) 10 2007 020 597.1

(51) Int. Cl. F16K 37/00; G05B 19/19; G05B 23/02; G05D 3/12

(52) U.S. Cl. 137/553; 700/66

(57) ABSTRACT

A method of checking the operability of an actuator is provided. The actuator includes a control valve adjustable via an actuating drive by an actuating element, a position sensor detecting the actual position of the actuating element, and an electropneumatic position controller creating a pneumatic controlled variable depending on an actual position and a target position. The target position is provided to the actuating drive via an activated magnetic valve. The actuating element is moved over a section of an adjustment path for an execution of a partial-stroke test of the actuating element, the adjustment movement being detected. The magnetic valve is deactivated for a short time such that the actuating element is moved over only a section of the adjustment path. To facilitate the monitoring of the operability of the actuator, the partial-stroke test and the test of the magnetic valve are performed in a single test sequence.

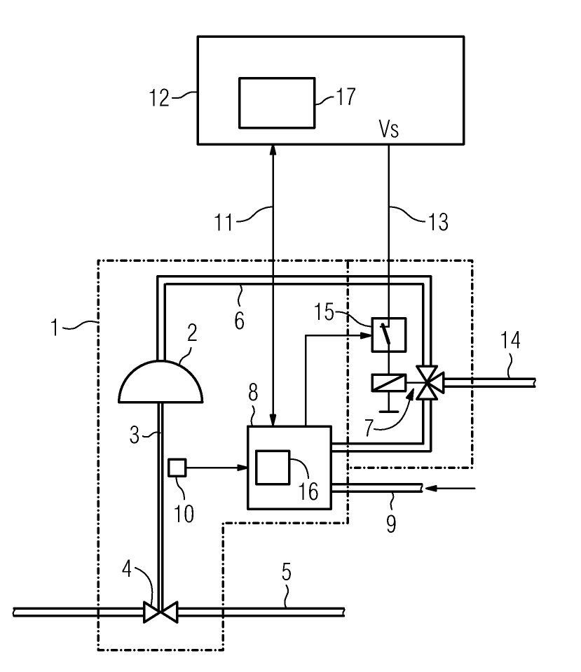

### CROSS REFERENCE TO RELATED APPLICATIONS

This application is the US National Stage of International Application No. PCT/EP2008/055104 filed Apr. 25, 2008, and claims the benefit thereof. The International Application claims the benefits of German Application No. 10 2007 020 597.1 DE filed May 2, 2007. All of the applications are incorporated by reference herein in their entirety.

### FIELD OF INVENTION

The invention relates to a method for checking the operability of an actuator comprising a control valve which can be displaced via an actuating drive by means of an actuating element engaging with the control valve, a position sensor which detects the actual position of the actuating element, and an electropneumatic position controller which generates a pneumatic controlled variable as a function of the actual position and a target position that is supplied to the actuating drive via an activated magnetic valve which can be deactivated in order to vent the actuating drive, wherein in order to conduct a partial-stroke test the actuating element is briefly moved over a part of its displacement path and in the process the displacement movement is recorded and wherein in order to test the magnetic valve the latter is deactivated briefly such that the actuating element moves over only a part of its displacement path.

### BACKGROUND OF INVENTION

A method of said type is known from US 2006/0219299 A1. In the case of the known method the actuating element or, as the case may be, the control valve is moved in the course of a partial-stroke test by means of the position controller from the respective current position over a part of its displacement path and is then moved back again. The change in position is so small in this case that the online operation of the plant in which the control valve is installed does not have to be interrupted and is disrupted only to an insignificant extent. During the partial-stroke test the displacement movement is recorded and stored.

In order to test the magnetic valve the latter is briefly deactivated through interruption of its voltage supply and in the process the pressure difference between the side connected to the position controller and the side connected to the actuating drive of the magnetic valve is monitored. The test of the magnetic valve is rated as successful if the pressure on the actuating drive side drops significantly during the temporary deactivation of the magnetic valve while the pressure delivered by the position controller remains largely unchanged.

### SUMMARY OF INVENTION

An object of the invention is to simplify the checking of the operability of the actuator while in addition enabling special pressure sensors and corresponding pneumatic connections to the position controller or, as the case may be, the magnetic valve to be dispensed with.

The object is achieved according to the invention in that in the case of the method of the type cited in the introduction the partial-stroke test and the testing of the magnetic valve are carried out in a single test sequence, wherein the magnetic valve is deactivated, the displacement movement of the actuating element is recorded and monitored to determine whether a predefined path change has been reached, and if the predefined path change is reached the magnetic valve is reactivated.

When the magnetic valve is deactivated, the actuating drive is pneumatically separated from the position controller and instead is vented such that the pressure in the actuating drive reduces and the actuating element is moved with the control valve, assisted for example by the action of a spring in the actuating drive. As soon as the actuating element has executed a predefined path change the magnetic valve is reactivated and the position controller controls the actuating element via the actuating drive so as to return it to its starting position. Thus, the operability of all parts of the actuator, including the magnetic valve, is tested in the single test sequence.

The displacement movement recorded during the test sequence and/or the path change reached are/is advantageously stored. Alternatively or in addition the time required from the deactivating of the magnetic valve to the reaching of the predefined path change is recorded and stored. Furthermore, following the reactivation of the magnetic valve the displacement movement of the actuating element until the starting position is reached and/or the time required therefor can advantageously be recorded and stored. In this way the test run is logged and it can be established whether the actuator responds quickly enough to changes in requirements.

In order to prevent prolonged venting of the actuating drive in the event of a malfunction, if the actuating element seizes up for example, the time required from the deactivating of the magnetic valve to the reaching of the predefined path change is preferably monitored to determine whether a predefined time period has been exceeded, with the magnetic valve being reactivated if the time period is exceeded.

The test can be automatically initiated, monitored and evaluated by means of a process control device outside of the actuator. Generally, however, the computing cycle times of process control devices are too long for directly controlling and evaluating the execution of a partial-stroke test. For this reason it is advantageously provided that the process control device supplies the magnetic valve with a supply voltage which can be switched off by the process control device in the event of an emergency, and that the supply voltage is supplied to the magnetic valve by way of a controllable switch which is opened and closed by the position controller for the purpose of starting and terminating the test sequence, respectively. In the event of an emergency, therefore, switching off the supply voltage of the magnetic valve causes the actuating element to be moved with the control valve into a safety or emergency position, while the test of the actuator is controlled and monitored by the position controller, which operates faster in comparison with the process control device. To that end the position controller can be triggered by the process control device in order to start the test sequence and communicate the test results to the process control device on completion of the test sequence.

### BRIEF DESCRIPTION OF THE DRAWINGS

For the purposes of further explanation of the invention reference is made in the following to the single figure of the drawing, which shows an exemplary embodiment of an actuator for performing the method according to the invention.

### DETAILED DESCRIPTION OF INVENTION

The actuator 1 includes a pneumatic actuating drive 2 which actuates a control valve 4 via an actuating element 3, in this case in the form of a lifting rod, and in so doing controls the fluid flow in a pipeline 5. The actuating drive 2 is connected via a pneumatic line 6 with a magnetic valve 7 disposed therein to a position controller 8 which is supplied with compressed air from a supply line 9. A position sensor 10 records the actual position of the actuating element 3 and supplies it to the position controller 8 which, as a function of the actual position and a predefinable target position, sets a variable pressure in the line 6 as a controlled variable in order to move the actuating element 3 with the valve 4 into the target position. In order to specify the target position the position controller 8 is connected to a process control device 12 via a communication line 11.

The magnetic valve 7, which can be disposed inside the actuator 1 or outside thereof, is embodied as a three-way valve and is supplied with a supply voltage Vs by the process control device 12 via a line 13.

Under normal conditions the supply voltage Vs is switched on, such that the magnetic valve 7 is activated and pneumatically connects the position controller 8 to the actuating drive 2. In an emergency situation the process control device 12 switches off the supply voltage Vs, with the result that the then deactivated magnetic valve 7 separates the actuating drive 2 from the position controller 8 and instead vents it via a magnetic valve outlet 14. The actuating drive 2 thereupon becomes depressurized and moves the actuating element 3 with the valve 4, assisted for example by the action of a spring in the actuating drive 2, into a safety position. In addition the deactivation and subsequent reactivation of the magnetic valve 7 can also be performed at the actuator 1 itself in that a controllable switch 15 disposed in the run of the line 13 is opened or, as the case may be, closed again.

In order to check the operability of the actuator 1 at regular intervals the process control device 12 automatically issues a corresponding command to the position controller 8 each time via the communication line 11. The position controller 8 thereupon generates a control signal in order to open the controllable switch 15 so that the magnetic valve 7 is deactivated and as a consequence thereof the actuating drive 2 is vented. The thereupon commencing movement of the actuating element 3 is recorded by the position sensor 10 and stored in a memory 16 of the position controller 8. The position controller 8 monitors the displacement movement of the actuating element 3 to determine whether a predefined parameterizable path change has been reached and if the predefined path change is reached generates a control signal in order to close the controllable switch 15 so that the magnetic valve 7 will be reactivated and the pneumatic connection reestablished between the position controller 8 and the actuating drive 2. The position controller 8 now controls the actuating element 3 with the control valve 4 such that it returns to the starting position before the test, with the displacement movement also now being recorded and stored.

In addition to the displacement movement, the times that the actuating element 3 requires from the deactivating of the magnetic valve 7 to the reaching of the predefined path change and subsequently from the reactivation of the magnetic valve 7 to the reaching of the starting position before the test are also recorded. In the process the time required from the deactivating of the magnetic valve 7 to the reaching of the predefined path change is monitored to determine whether it exceeds a predefined, likewise parameterizable, time period and if said time period is exceeded the magnetic valve 7 is reactivated in order to prevent a prolonged venting of the actuating drive 2 in the event of a malfunction, a seizing-up of the actuating element, for example. The regulating speed of the actuator 1 is tested by way of the time recording during the return movement of the actuating element 3 into the starting position.

The position controller 8 communicates the test results, i.e. the stored displacement movements and associated times to the process control device 12. The test results transmitted during successive tests of the actuator 1 can be compared with one another in an evaluation device 17 of the device 12 and analyzed for the purpose of identifying change trends in order thereby e.g. to diagnose an increased level of wear and tear in the actuator 1.

1.-8. (canceled)

9. A method of checking the operability of an actuator, comprising:
providing an actuator with a control valve displaceable via an actuating drive by an actuating element engaging with the control valve, a position sensor detecting an actual position of the actuating element, and an electropneumatic position controller generating a pneumatic controlled variable as a function of the actual position and a target position, the pneumatic controlled variable being supplied to the actuating drive via an activated magnetic valve which is deactivated in order to vent the actuating drive;
moving briefly the actuating element over a part of its displacement path in order to conduct a partial-stroke test;
recording the moving of the actuating element;
deactivating briefly the magnetic valve such that the actuating element moves over only a part of its displacement path in order to test the magnetic valve,
wherein the partial-stroke test and the test of the magnetic valve are conducted in a single test sequence such that
the magnetic valve is deactivated,
the displacement movement of the actuating element is recorded and monitored to determine whether a predefined path change has been reached, and
the magnetic valve is reactivated when a predefined path change is reached.

10. The method as claimed in claim 9, further comprising:
storing the displacement movement recorded during the test sequence or the path change reached.

11. The method as claimed in claim 9, further comprising:
storing the displacement movement recorded during the test sequence and the path change reached.

12. The method as claimed in claim 10, further comprising:
recording and storing the displacement movement following the reactivation of the magnetic valve until the starting position of the actuating element is reached before the test.

13. The method as claimed in claim 11, further comprising:
recording and storing the displacement movement following the reactivation of the magnetic valve until the starting position of the actuating element is reached before the test.

14. The method as claimed in claim 9, further comprising:
recording and storing a time required from the deactivating of the magnetic valve until the predefined path change is reached.

15. The method as claimed in claim 10, further comprising:
recording and storing a time required from the deactivating of the magnetic valve until the predefined path change is reached.

16. The method as claimed in claim 11, further comprising:
recording and storing a time required from the deactivating of the magnetic valve until the predefined path change is reached.

17. The method as claimed in claim 15, further comprising:
monitoring the recorded time to determine whether it exceeds a predefined time period; and
reactivating the magnetic valve when the time period is exceeded.

18. The method as claimed in claim 16, further comprising:
monitoring the recorded time to determine whether it exceeds a predefined time period; and
reactivating the magnetic valve when the time period is exceeded.

19. The method as claimed in claim 15, further comprising:
recording and storing the time required from the reactivation of the magnetic valve to the reaching of the starting position of the actuating element before the test.

20. The method as claimed in claim 17, further comprising:
recording and storing the time required from the reactivation of the magnetic valve to the reaching of the starting position of the actuating element before the test.

21. The method as claimed in claim 9, wherein a process control device supplies the magnetic valve with a supply voltage which is switched off by the process control device in an emergency event, and wherein the supply voltage is supplied to the magnetic valve via a controllable switch which is opened and closed by the position controller in order to start and terminate the test sequence.

22. The method as claimed in claim 21, wherein the position controller is triggered by the process control device in order to start the test sequence.
